(19) United States
(12) Patent Application Publication
(10) Pub. No.: US 2024/0429574 A1
(43) Pub. Date: Dec. 26, 2024

(54) BATTERY SAFETY MECHANISM AND BATTERY

(71) Applicant: Murata Manufacturing Co., Ltd., Nagaokakyo-shi (JP)

(72) Inventors: Hideaki YAMADA, Nagaokakyo-shi (JP); Toshifumi KAMIKIDO, Nagaokakyo-shi (JP); Takuya KIHARA, Nagaokakyo-shi (JP); Yusuke TANJI, Nagaokakyo-shi (JP); Yoshihisa SUGIURA, Nagaokakyo-shi (JP); Moe OKADA, Nagaokakyo-shi (JP)

(21) Appl. No.: 18/823,896

(22) Filed: Sep. 4, 2024

Related U.S. Application Data
(63) Continuation of application No. PCT/JP2023/006960, filed on Feb. 27, 2023.

(30) Foreign Application Priority Data
Mar. 18, 2022 (JP) 2022-043516

(51) Int. Cl. H01M 50/578; H01M 50/107; H01M 50/152; H01M 50/342

(52) U.S. Cl. CPC H01M 50/578; H01M 50/107; H01M 50/152; H01M 50/3425

(57) ABSTRACT

A safety mechanism of a battery that includes: a lid; a pressure release member in contact with the lid and constructed to be deformed when an internal pressure of the battery increases so as to release a gas inside the battery to an outside of the battery; a current shutoff member on a side opposite to the lid with respect to the pressure release member, and connected to the pressure release member so as to shut off a current flowing to the pressure release member when the internal pressure of the battery increases; and an insulating adhesive layer interposed between the pressure release member and the current shutoff member and bonding the pressure release member to the current shutoff member.

### CROSS REFERENCE TO RELATED APPLICATIONS

The present application is a continuation of International application No. PCT/JP2023/006960, filed Feb. 27, 2023, which claims priority to Japanese Patent Application No. 2022-043516, filed Mar. 18, 2022, the entire contents of each of which are incorporated herein by reference.

### TECHNICAL FIELD

The present disclosure relates to a battery safety mechanism and a battery.

### BACKGROUND ART

A variety of electronic devices such as a mobile phone and a personal digital assistant (PDA) are widely used, and there is a demand for downsizing, weight saving, and prolonged lifetime of the electronic devices. Therefore, as a power source, a battery, particularly a secondary battery that is small in size, lightweight, and capable of obtaining a high energy density has been developed. In addition, a secondary battery including a safety mechanism for releasing a gas generated by decomposition or the like of an electrolytic solution to an outside of the battery is known.

Patent Document 1 discloses a battery including such a safety mechanism. FIG. 16 is a view schematically illustrating a safety mechanism 200 and a configuration around the safety mechanism 200 in a battery disclosed in Patent Document 1.

As illustrated in FIG. 16, a battery safety mechanism 200 disclosed in Patent Document 1 includes a battery lid 201, a disk plate 202 that is deformed when an internal pressure of a battery increases and has a pressure release function for releasing a gas inside the battery to the outside, a current shutoff member 203 that shuts off current when the internal pressure of the battery increases, and an insulating disk holder 204 interposed between the disk plate 202 and the current shutoff member 203. The current shutoff member 203 includes a shutoff disk 203a and a sub disk 203b. The disk plate 202 has a protrusion portion 202a protruding toward the current shutoff member 203. The protrusion portion 202a is connected to the sub disk 203b through a hole 203c provided in the shutoff disk 203a. The disk holder 204 which is an insulating material includes a molded resin.

In the safety mechanism 200 of the battery, when the internal pressure of the battery increases, the disk plate 202 is lifted toward the battery lid 201, and the protrusion portion 202a separates from the sub disk 203b connected to a positive electrode lead 210, and thus current flowing to the disk plate 202 and the battery lid 201 is shut off. Further, it is configured such that the disk plate 202 is provided with a groove and broken at a position where the groove is provided, and thus the gas generated inside the battery flows toward the battery lid 201 and is discharged to the outside through a hole provided in the battery lid 201.

### Patent Document 1: WO 2018/042777

### SUMMARY OF THE DISCLOSURE

The safety mechanism of the battery preferably has a thin structure. For example, when a size of the battery is determined, an internal volume of the battery can be increased by thinning the safety mechanism. Therefore, since sizes of the positive electrode, the negative electrode, and the like can be increased, battery capacity can be further increased. The battery described in Patent Document 1 has a thin safety mechanism, but there is still room for improvement in further reduction in thickness.

The present disclosure solves the above problems, and an object of the present disclosure is to provide a safety mechanism of a thinner battery and a battery including such a safety mechanism.

A safety mechanism of a battery of the present disclosure includes: a lid; a pressure release member in contact with the lid and constructed to be deformed when an internal pressure of the battery increases so as to release a gas inside the battery to an outside of the battery; a current shutoff member on a side opposite to the lid with respect to the pressure release member, and connected to the pressure release member so as to shut off a current flowing to the pressure release member when the internal pressure of the battery increases; and an insulating adhesive layer interposed between the pressure release member and the current shutoff member and bonding the pressure release member to the current shutoff member.

According to the safety mechanism of the battery of the present disclosure, since the insulating material interposed between the pressure release member and the current shutoff member is the insulating adhesive layer, the safety mechanism can be made thinner as compared with a case of using the insulating material including the molded resin or the like.

### BRIEF EXPLANATION OF THE DRAWINGS

FIG. 1 is a sectional view schematically illustrating a configuration of a battery including a safety mechanism of the battery according to a first embodiment of the present disclosure.

FIG. 2 is a sectional view schematically illustrating a configuration of the safety mechanism of the battery according to the first embodiment of the present disclosure.

FIG. 3 is an exploded perspective view of the safety mechanism of the battery according to the first embodiment of the present disclosure.

FIG. 4 is a plan view when the pressure release member is viewed from a current shutoff member side in a stacking direction.

FIG. 5 is a plan view of the pressure release member when a shape of a first groove and a second groove is an arc shape as viewed from the current shutoff member side in the stacking direction.

FIG. 6(a) is a view for schematically illustrating a current shutoff function of the current shutoff member, and

FIG. 6(b) is a view for schematically illustrating a pressure release function of the pressure release member.

FIGS. 7(a) to 7(c) are plan views illustrating examples of an adhesive layer having a shape other than an annular shape.

FIGS. 8(a) to 8(d) are views for illustrating a process in which adhesion between the pressure release member and the adhesive layer of the safety mechanism of the battery according to a second embodiment is deteriorated.

FIGS. 9(a) to 9(c) are views for illustrating a process in which adhesion between the pressure release member and the adhesive layer of the safety mechanism of the battery according to the first embodiment is deteriorated.

FIG. 10(a) is a view illustrating a relationship between expected lifespan and adhesive strength of the adhesive layer of the safety mechanism of the battery according to the first embodiment and the second embodiment, and FIG. 10(b) is a view illustrating a relationship between the expected lifespan and the adhesive strength of the adhesive layer of the safety mechanism of the battery according to the second embodiment.

FIG. 11 is a view illustrating a relationship between the number of times of roughening treatment performed on the pressure release member and a surface area ratio of a roughened surface of the pressure release member.

FIG. 12(a) is a view illustrating a surface state when the roughening treatment is not performed on the pressure release member, FIG. 12(b) is a view illustrating a surface state when the roughening treatment is performed on the pressure release member once, and FIG. 12(c) is a view illustrating a surface state when the roughening treatment is performed on the pressure release member twice.

FIG. 13 is a view illustrating the relationship between the expected lifespan and the adhesive strength when the number of times of the roughening treatment is changed.

FIG. 14 is a view for illustrating a configuration of an electrode assembly.

FIG. 15 is a sectional view schematically

illustrating a configuration of the safety mechanism of the battery in a case where the pressure release member has a projection and a flat plate portion, and the current shutoff member has a flat plate shape.

FIG. 16 is a sectional view schematically illustrating a safety mechanism and a configuration around the safety mechanism in a battery disclosed in Patent Document 1.

### DESCRIPTION OF THE PREFERRED EMBODIMENTS

Hereinafter, features of the present disclosure will be specifically described with reference to an embodiment of the present disclosure.

### First Embodiment

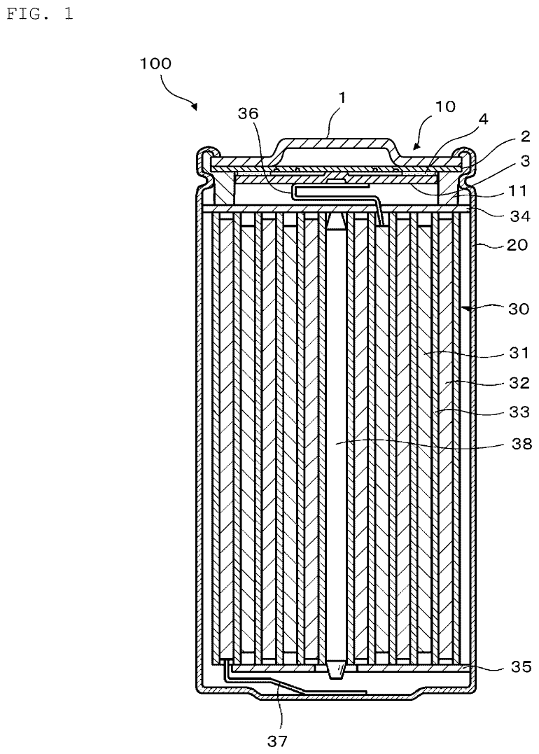

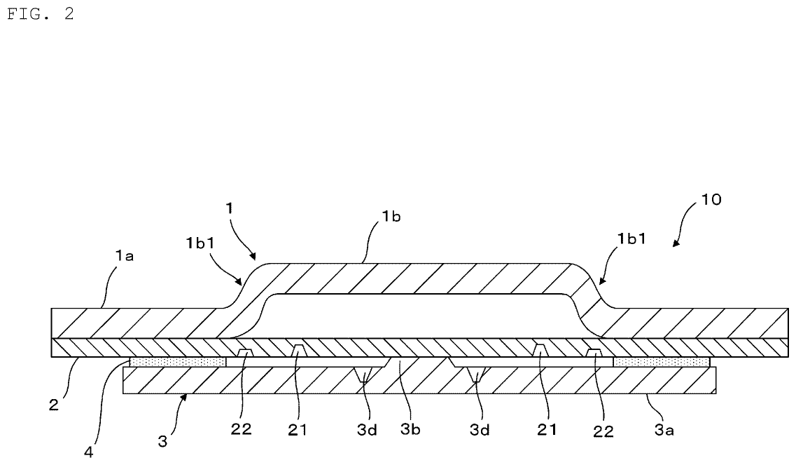

FIG. 1 is a sectional view schematically illustrating a configuration of a battery 100 including a safety mechanism 10 of the battery according to a first embodiment of the present disclosure. FIG. 2 is a sectional view schematically illustrating a configuration of the safety mechanism 10 of the battery according to the first embodiment of the present disclosure. FIG. 3 is an exploded perspective view of the safety mechanism 10 of the battery.

Here, the embodiment will be described assuming that the battery 100 is a cylindrical lithium ion secondary battery. However, a type of the battery 100 is not limited to a lithium ion battery, and may be another type of battery such as a manganese battery, a nickel-metal hydride battery, or a nickel-cadmium battery. Further, the battery 100 is not limited to a secondary battery and may be a primary battery. Furthermore, a shape of the battery 100 is not limited to a cylindrical shape, and may be another shape such as a square shape or a button shape.

The safety mechanism 10 of the battery includes a lid 1, a pressure release member 2, a current shutoff member 3, and an adhesive layer 4.

The lid 1 is a member for sealing an opening of a battery can 20 described later. As illustrated in FIG. 2, the lid 1 has a flat plate portion 1a having a flat plate shape, and a protrusion portion 1b that is positioned at a center portion of the lid 1 in a mode surrounded by the flat plate portion 1a and protrudes to the outside of the battery 100. Since the protrusion portion 1b of the lid 1 has a shape protruding to the outside of the battery 100, the protrusion portion 1b includes a bent portion 1b1 extending from the flat plate portion 1a toward the outside of the battery 100. A portion of the protrusion portion 1b of the lid 1 other than the bent portion 1b1 has a flat plate shape similarly to the flat plate portion 1a.

A thickness of the lid 1 is, for example, 1.5 mm to 3.0 mm. In the battery 100 in the present embodiment, the lid 1 functions as a positive electrode terminal of the battery 100, and the battery can 20 functions as a negative electrode terminal. The lid 1 and the battery can 20 are insulated from each other. The lid 1 is provided with a discharge hole 1c for discharging a gas generated inside the battery 100 to the outside of the battery 100. The lid 1 includes, for example, a conductive material such as steel such as SPCC, stainless steel (SUS) such as SUS430 or SUS304, nickel (Ni), aluminum (Al), or titanium (Ti).

The pressure release member 2 is a member that is in contact with the lid 1 and is deformed when the internal pressure of the battery increases to release the gas inside the battery to the outside. As illustrated in FIG. 3, the pressure release member 2 has a flat plate shape, and has a thickness of, for example, 0.2 mm to 0.5 mm. A shape of the pressure release member 2 when viewed in a stacking direction (hereinafter, simply referred to as the stacking direction) of the lid 1, the pressure release member 2, the adhesive layer 4, and the current shutoff member 3 is circular. However, the shape of the pressure release member 2 is not limited to a circular shape.

The pressure release member 2 includes, for example, a conductive material such as aluminum such as A1050, A3203, or A5052, titanium, platinum (Pt), or gold (Au). Since the pressure release member 2 includes at least one of aluminum, titanium, platinum, and gold, reaction decomposition in the lithium ion secondary battery can be prevented.

The pressure release member 2 has at least one groove so as to be deformed when the internal pressure of the battery increases. As such a groove, the pressure release member 2 in the present embodiment includes a first groove 21 and a second groove 22 located radially outside the first groove 21. As illustrated in FIG. 2, the first groove 21 and the second groove 22 are provided between a connection position between a projection 3b of the current shutoff member 3 to be described later and the pressure release member 2 and a position where the lid 1 and the pressure release member 2 are in contact with each other in a direction perpendicular to the stacking direction.

In the present embodiment, each of the first groove 21 and the second groove 22 of the pressure release member 2 is open toward the current shutoff member 3. Since each of the first groove 21 and the second groove 22 is open toward the current shutoff member 3, the pressure release member 2 can be broken with a smaller amount of displacement when the internal pressure of the battery increases as compared with a configuration in which they are open toward the lid 1.

However, each of the first groove 21 and the second groove 22 of the pressure release member 2 may be open toward the lid 1. In addition, only one groove may be provided in the pressure release member 2, or three or more grooves may be provided.

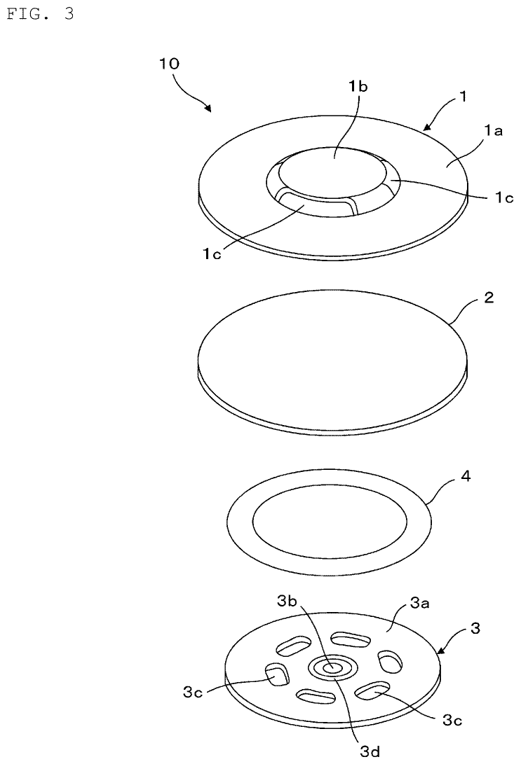

FIG. 4 is a plan view when the pressure release member 2 is viewed from the current shutoff member 3 side in the stacking direction. As illustrated in FIG. 4, in the present embodiment, shapes of the first groove 21 and the second groove 22 when viewed in the stacking direction are both circular. In addition, the first groove 21 and the second groove 22 form concentric circles.

However, the shapes of the first groove 21 and the second groove 22 when viewed in the stacking direction are not limited to circular shapes. For example, as illustrated in FIG. 5, the shapes of the first groove 21 and the second groove 22 when viewed in the stacking direction may be arc shapes. FIG. 5 illustrates an example in which three arc-shaped first grooves 21 and three arc-shaped second grooves 22 are provided, but the number is not limited to three.

Depths of the first groove 21 and the second groove 22 are different from each other. Specifically, the first groove 21 is deeper than the second groove 22. Since the first groove 21 is deeper than the second groove 22, the pressure release member 2 is broken at a position where the first groove 21 is provided when the internal pressure of the battery increases. A depth of the first groove 21 is, for example, 0.11 mm to 0.2 mm, and a depth of the second groove 22 is, for example, 0.1 mm to 0.19 mm

As illustrated in FIG. 2, the second groove 22 of the pressure release member 2 is located near an inner contact end in a region where the lid 1 and the pressure release member 2 are in contact with each other. “Near an inner contact end” means a range within 1.5 mm radially inward from the inner contact end. As illustrated in FIG. 2, the pressure release member 2 is in contact with the flat plate portion 1a of the lid 1 and is not in contact with the bent portion 1b1. The second groove 22 of the pressure release member 2 is more preferably provided at a position overlapping the bent portion 1b1 of the protrusion portion 1b of the lid 1 in the stacking direction.

Since the second groove 22 of the pressure release member 2 is located near the inner contact end in the region where the lid 1 and the pressure release member 2 are in contact with each other, the pressure release member 2 is, as described later, less likely to be deformed along the bent portion 1b1 of the lid 1 at the position where the second groove 22 is provided when the internal pressure of the battery increases. This makes it possible to suppress positional deviation and the like of the lid 1. In addition, it is possible to suppress an influence on processing variation of the lid 1. The pressure release member 2 is easily broken at the position where the first groove 21 is provided.

The current shutoff member 3 is connected to a positive electrode lead 36 led out from an electrode assembly 30 of the battery 100 described later. The current shutoff member 3 is disposed on a side opposite to the lid 1 with respect to the pressure release member 2, and connected to the pressure release member 2, and is a member for shutting off a current flowing to the pressure release member 2 when the internal pressure of the battery increases. The current shutoff member 3 has a flat plate shape as a whole. Specifically, as illustrated in FIGS. 2 and 3, the current shutoff member 3 includes a flat plate portion 3a having a flat plate shape, and a projection 3b that is located at a center portion of the current shutoff member 3 in a mode surrounded by the flat plate portion 3a, projects toward the pressure release member 2 with respect to the flat plate portion 3a, and is for connecting to the pressure release member 2.

In the present embodiment, a shape of an outer peripheral end of the current shutoff member 3 is circular when viewed in the stacking direction. Further, the shape of the projection 3b of the current shutoff member 3 is circular when viewed in the stacking direction. A thickness of the flat plate portion 3a and the projection 3b of the current shutoff member 3 is, for example, 0.25 mm to 0.5 mm. The thickness of the projection 3b is substantially the same as that of the adhesive layer 4 to be described later, and is, for example, 0.05 mm to 0.4 mm. The current shutoff member 3 is not a perfect flat plate because of having the projection 3b, but since the thickness of the projection 3b is thin, the current shutoff member 3 can be regarded as a flat plate shape as a whole.

In the present embodiment, the projection 3b of the current shutoff member 3 is connected to the pressure release member 2. In the present embodiment, the projection 3b of the current shutoff member 3 is joined to the pressure release member 2.

As illustrated in FIG. 3, the flat plate portion 3a of the current shutoff member 3 may be provided with a plurality of holes 3c through which the gas generated inside the battery passes. In the present embodiment, six holes 3c are provided around the projection 3b. However, the number of the holes 3c is not limited to six, and a shape thereof is not limited to a shape illustrated in FIG. 3. The holes 3c are provided at positions not overlapping the first groove 21 and the second groove 22 of the pressure release member 2 in the stacking direction, and is configured such that the gas generated inside the battery 100 flows from the holes 3c toward the pressure release member 2.

Note that it is also possible to have a configuration in which the hole 3c is not provided depending on a shape of the current shutoff member 3. The holes 3c may be provided at positions overlapping the first groove 21 and/or the second groove 22 of the pressure release member 2 in the stacking direction.

The current shutoff member 3 includes, for example, a conductive material such as aluminum such as A1050, A3203, or A5052, titanium, platinum, or gold. Since the current shutoff member 3 includes at least one of aluminum, titanium, platinum, and gold, the reaction decomposition in the lithium ion secondary battery can be prevented.

The current shutoff member 3 has a groove 3d open toward the pressure release member 2, between a position where the current shutoff member 3 and the pressure release member 2 are connected to each other and a position where the current shutoff member 3 and the adhesive layer 4 are in contact with each other, in the direction perpendicular to the stacking direction. A depth of the groove 3d is, for example, 0.2 mm to 0.46 mm. In the present embodiment, the groove 3d is provided near the projection 3b of the current shutoff member 3 so as to surround the projection 3b. The shape of the groove 3d when viewed in the stacking direction is circular. However, the shape of the groove 3d is not limited to a circular shape, and may be another shape such as an arc shape.

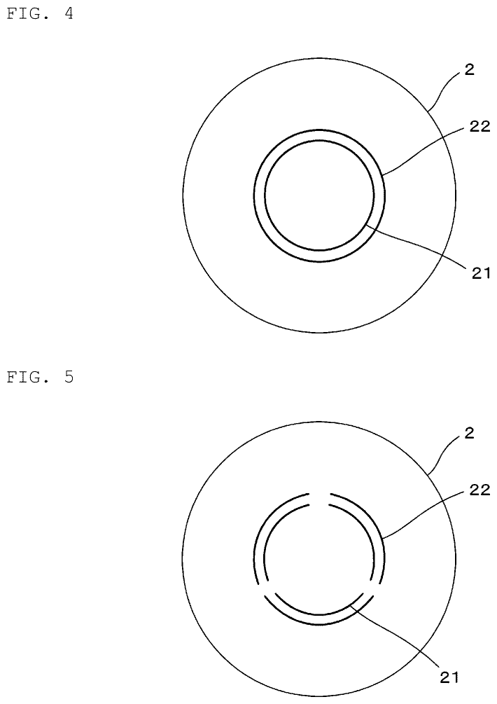

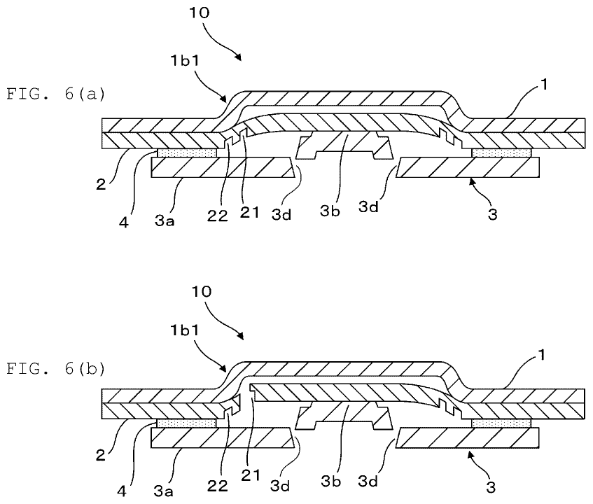

FIG. 6(a) is a view for schematically illustrating a

current shutoff function of the current shutoff member 3, and

FIG. 6(b) is a view for schematically illustrating a pressure release function of the pressure release member 2. When the internal pressure of the battery 100 increases due to internal short circuit of the battery 100, heating from the outside of the battery 100, or the like, as illustrated in

FIG. 6(a), a portion including the projection 3b is separated from the flat plate portion 3a at a position where the groove 3d of the current shutoff member 3 is formed. Thus, since the portion including the projection 3b separated from the flat plate portion 3a is also separated from the positive electrode lead 36 (see FIG. 1), a current flowing from the positive electrode lead 36 to the pressure release member 2 via the current shutoff member 3 is shut off. Further, as illustrated in FIG. 6(a), in the pressure release member 2 connected to the projection 3b of the current shutoff member 3, a portion not in contact with the lid 1 is deformed to bulge toward the lid 1.

Further, when the internal pressure of the battery further increases due to the gas or the like generated inside the battery 100, a force of pushing the pressure release member 2 toward the lid 1 increases, and the pressure release member 2 is cut at the position where the first groove 21 is provided as illustrated in FIG. 6(b). That is, the pressure release member 2 is deformed such that a portion near the position where the second groove 22 is provided follows the bent portion 1b1 of the lid 1, and is cut at the position where the first groove 21 having a depth deeper than that of the second groove 22 is provided. Thus, the gas generated inside the battery 100 flows toward the lid 1, and is discharged to the outside through a hole (not illustrated) provided in the lid 1.

The adhesive layer 4 has an insulating property and is interposed between the pressure release member 2 and the current shutoff member 3 to bond the pressure release member 2 and the current shutoff member 3 to each other. More specifically, the adhesive layer 4 is disposed between the pressure release member 2 and the current shutoff member 3 and radially outside the second groove 22 of the pressure release member 2. Since the insulating adhesive layer 4 is interposed between the pressure release member 2 and the current shutoff member 3, the pressure release member 2 connected to the positive electrode lead 36 and the current shutoff member 3 can be insulated from each other when the current shutoff function of the current shutoff member 3 is performed (see FIG. 6(a)).

The adhesive layer 4 includes any one of a thermosetting resin, a thermoplastic resin, a UV curable resin, and an anaerobic adhesive. Specifically, as the adhesive layer 4, an epoxy resin-based adhesive containing an epoxy resin as a main component, an acrylic resin-based adhesive containing an acrylic resin as a main component, a fluororesin-based adhesive containing a fluororesin as a main component, a silicone resin-based adhesive containing a silicone resin as a main component, a synthetic resin-based adhesive containing a synthetic resin as a main component, a urethane resin-based adhesive containing a urethane resin as a main component, or the like can be used.

When the thermosetting resin is used as the adhesive layer 4, a glass transition temperature Tg is preferably 100° C. or higher, and more preferably 170° C. or higher. Examples of the thermosetting resin having a glass transition temperature Tg of 100° C. or higher include epoxy resins. A viscosity of the epoxy resin that is a thermosetting resin is, for example, 80 Pa·s to 130 Pa·s. Further, when the thermosetting resin is used as the adhesive layer 4, a melting point Tm is preferably 200° C. or higher, and more preferably 270° C. or higher. When the adhesive layer 4 includes the thermosetting resin having a glass transition temperature Tg of 100° C. or higher or the thermoplastic resin having a melting point Tm of 200° C. or higher, the insulating adhesive layer 4 continues to be interposed between the pressure release member 2 and the current shutoff member 3 no matter when a temperature of the battery reaches a high temperature of several hundred ° C. Therefore, when the current shutoff function of the current shutoff member 3 is performed (see FIG. 6(a)), an insulating state between the pressure release member 2 connected to the positive electrode lead 36 and the current shutoff member 3 can be maintained, and occurrence of short circuit can be prevented.

In the present embodiment, the adhesive layer 4 has an annular shape as illustrated in FIG. 3 when viewed in the stacking direction. The adhesive layer 4 can be formed using, for example, a dispenser. The thickness of the adhesive layer 4 is, for example, 0.05 mm to 0.4 mm. Further, an area of the adhesive layer 4 is, for example, 0.6 mm² to 100 mm².

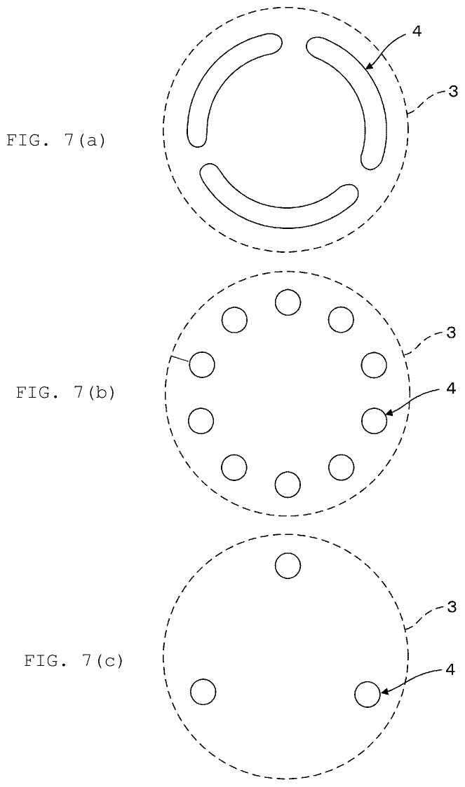

However, the shape of the adhesive layer 4 when viewed in the stacking direction is not limited to the annular shape. FIGS. 7(a) to 7(c) are views illustrating examples of the adhesive layer 4 having a shape other than the annular shape. The adhesive layer 4 illustrated in FIG. 7(a) has a shape in which an annular ring is divided. The adhesive layer 4 illustrated in FIG. 7(a) has a shape in which the annular ring is divided into three, but may have a shape in which the annular ring is divided into two, or may have a shape in which the annular ring is divided into four or more. The adhesive layer 4 illustrated in FIGS. 7(b) and 7(c) includes a plurality of dots having a predetermined size. In FIG. 7(b), the number of dots is 10, and in FIG. 7 (c), the number of dots is 3, but the number of dots can be any number. Further, the size of one dot can also be any size. The adhesive layer 4 illustrated in FIGS. 7(a) to 7(c) can be formed by a method using a dispenser, or printing.

As illustrated in FIGS. 7(a) to 7(c), since the adhesive layer 4 is configured to be discontinuously arranged at a plurality of positions, a part of a pressure applied from the current shutoff member 3 toward the pressure release member 2 can be released from between adjacent adhesive layers 4, so that the pressure applied to the pressure release member 2 can be adjusted. On the other hand, as illustrated in FIG. 3, when the shape of the adhesive layer 4 is an annular shape, an adhesive force between the pressure release member 2 and the current shutoff member 3 can be further increased.

As described above, in the safety mechanism 10 of the battery according to the present embodiment, since the insulating material interposed between the pressure release member 2 and the current shutoff member 3 is the insulating adhesive layer 4 including an adhesive, a distance between the pressure release member 2 and the current shutoff member 3 can be shortened and the safety mechanism 10 can be thinned as compared with a case of using the insulating material including the molded resin or the like.

Further, in the safety mechanism of the battery disclosed in Patent Literature 1, since the disk plate that is the pressure release member, the insulating disk holder, and the shutoff disk constituting the current shutoff member are fixed by being crimped, the thickness of each member increases in order to obtain rigidity required for crimping. In contrast, in the safety mechanism 10 of the battery according to the present embodiment, since the pressure release member 2 and the current shutoff member 3 are bonded together through the adhesive layer 4, rigidity required for crimping is unnecessary, and the safety mechanism 10 of the battery can be thinned.

Further, in the safety mechanism of the battery disclosed in Patent Document 1, since the disk plate that is the pressure release member, the insulating disk holder, and the shutoff disk constituting the current shutoff member are fixed by being crimped, fixing strength is not so strong. Therefore, it is necessary to increase the thickness of each member in order to obtain rigidity necessary for assembly and conveyance. In contrast, in the safety mechanism 10 of the battery according to the present embodiment, since the pressure release member 2 and the current shutoff member 3 are bonded together through the adhesive layer 4, the fixing strength is strong. Therefore, it is not necessary to increase the thickness of each member in order to obtain the rigidity necessary for assembly and conveyance, so that the safety mechanism 10 of the battery can be thinned.

Further, in the safety mechanism 10 of the battery according to the present embodiment, since the pressure release member 2 and the current shutoff member 3 are bonded together through the adhesive layer 4, resistance to an increase in the internal pressure of the battery or an impact from the outside of the battery is increased, and safety of the battery 100 is improved.

### Second Embodiment

The safety mechanism 10 of the battery according to a second embodiment is different from the safety mechanism 10 of the battery according to the first embodiment in structures of the pressure release member 2 and the current shutoff member 3.

In the present embodiment, a surface of the pressure release member 2 facing the current shutoff member 3 is a roughened surface subjected to a roughening treatment. Further, a surface of the current shutoff member 3 facing the pressure release member 2 is a roughened surface subjected to the roughening treatment. The roughened surface of the pressure release member 2 and the roughened surface of the current shutoff member 3 have fine irregularities. The roughening treatment can be performed, for example, by irradiating a surface to be roughened with a laser beam.

However, the roughening treatment may be performed not on the entire surface of the pressure release member 2 facing the current shutoff member 3 but only on a region directly in contact with the adhesive layer 4. Similarly, the roughening treatment may be performed not on the entire surface of the current shutoff member 3 facing the pressure release member 2 but only on a region directly in contact with the adhesive layer 4.

Since the surface of the pressure release member 2 facing the current shutoff member 3 is the roughened surface, not only hydrogen bonding by the adhesive but also an anchor effect due to the fine irregularities present on the roughened surface are generated between the pressure release member 2 and the adhesive layer 4, so that the adhesive force between the pressure release member 2 and the adhesive layer 4 can be further improved.

Similarly, since the surface of the current shutoff member 3 facing the pressure release member 2 is the roughened surface, not only hydrogen bonding by the adhesive but also the anchor effect due to the fine irregularities present on the roughened surface are generated between the current shutoff member 3 and the adhesive layer 4, so that the adhesive force between the current shutoff member 3 and the adhesive layer 4 can be further improved.

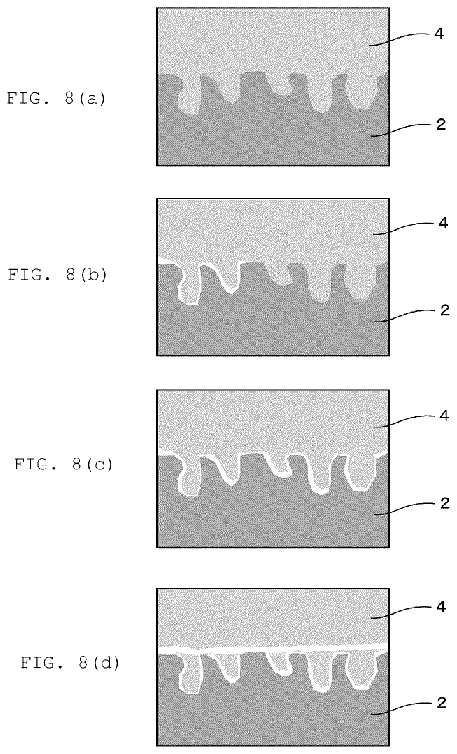

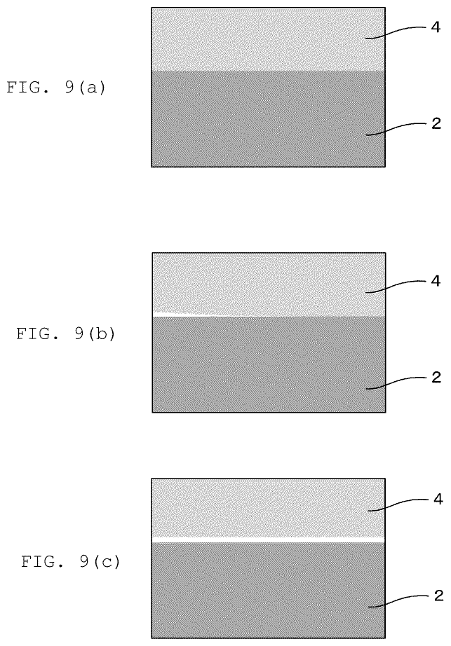

FIGS. 8(a) to 8(d) are views for illustrating a process in which adhesion between the pressure release member 2 and the adhesive layer 4 of the safety mechanism 10 of the battery according to the second embodiment is deteriorated. Although description using the drawings is omitted, the same applies to a process in which adhesion between the current shutoff member 3 and the adhesive layer 4 is deteriorated.

FIG. 8(a) is an enlarged sectional view of a boundary portion between the pressure release member 2 and the adhesive layer 4 before permeation of an electrolytic solution in a manufacturing process of the battery 100. In a state before the electrolytic solution is permeated, the pressure release member 2 is fixed to the adhesive layer 4 by hydrogen bonding by the adhesive constituting the adhesive layer 4 and the anchor effect caused by the adhesive constituting the adhesive layer 4 entering between the fine irregularities present on the surface of the pressure release member 2.

When the electrolytic solution is permeated from a state illustrated in FIG. 8(a), as illustrated in FIG. 8(b), hydrogen bonds are broken from a contact side of the electrolytic solution, and a gap starts to be formed between the pressure release member 2 and the adhesive layer 4. When the electrolytic solution further permeates and time elapses, as illustrated in FIG. 8(c), the hydrogen bonds are broken at all positions where the hydrogen bonds of the adhesive have been formed, and a gap is formed between the pressure release member 2 and the adhesive layer 4. However, in a state illustrated in FIG. 8(c), the adhesion between the pressure release member 2 and the adhesive layer 4 is maintained by the anchor effect.

Thereafter, since a cohesive strength of the adhesive continues to decrease with a lapse of time, as illustrated in FIG. 8(d), a root of an anchor portion where the anchor effect occurs starts to break, and the adhesive layer 4 is finally peeled off from the pressure release member 2.

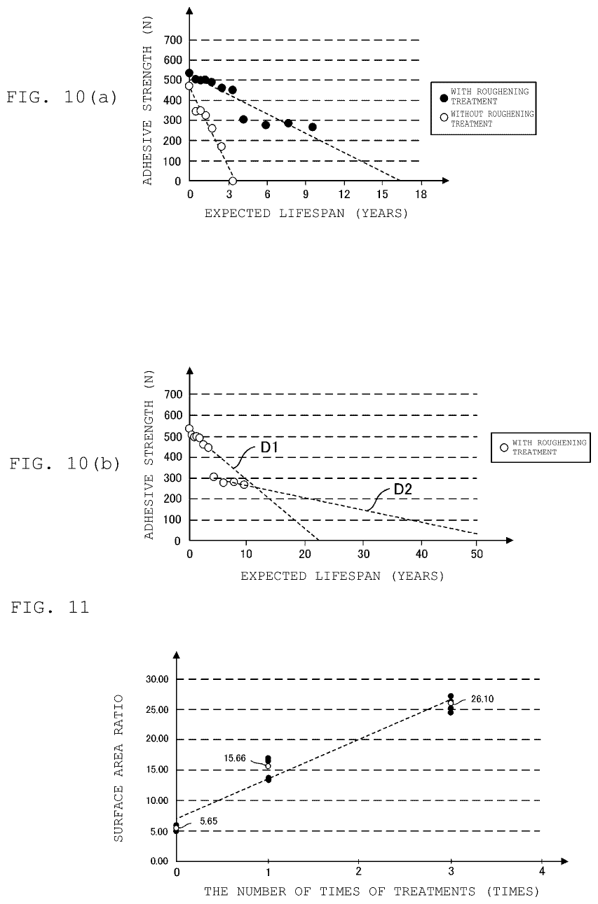

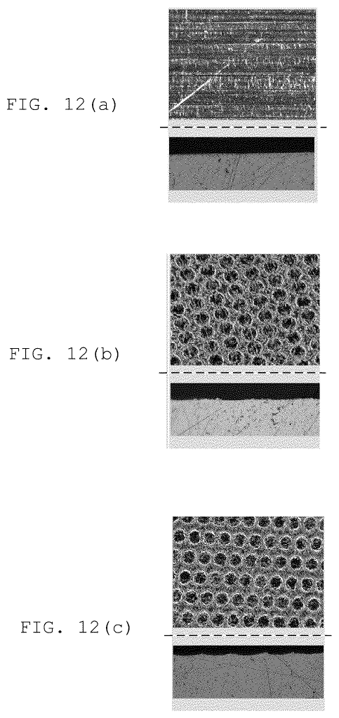

FIGS. 9(a) to 9(c) are views for illustrating a process in which the adhesion between the pressure release member 2 and the adhesive layer 4 of the safety mechanism 10 of the battery according to the first embodiment is deteriorated. In the safety mechanism 10 of the battery according to the first embodiment, the surface of the pressure release member 2 facing the current shutoff member 3 and the surface of the current shutoff member 3 facing the pressure release member 2 are not subjected to the roughening treatment. Although description using the drawings is omitted, the same applies to a process in which adhesion between the current shutoff member 3 and the adhesive layer 4 is deteriorated.

FIG. 9(a) is an enlarged sectional view of a boundary portion between the pressure release member 2 and the adhesive layer 4 before permeation of the electrolytic solution in the manufacturing process of the battery 100. In the state before the electrolytic solution is permeated, the pressure release member 2 is fixed to the adhesive layer 4 by hydrogen bonding by the adhesive constituting the adhesive layer 4.

When the electrolytic solution is permeated from a state illustrated in FIG. 9(a), as illustrated in FIG. 9(b), the hydrogen bonds are broken from the contact side of the electrolytic solution, and the gap starts to be formed between the pressure release member 2 and the adhesive layer 4. When the electrolytic solution further permeates and time elapses, as illustrated in FIG. 9 (c), the hydrogen bonds are broken at all positions where the hydrogen bonds of the adhesive have been formed, and the gap is formed between the pressure release member 2 and the adhesive layer 4. In a state illustrated in FIG. 9(c), the adhesion between the pressure release member 2 and the adhesive layer 4 is not maintained, and the adhesive layer 4 is peeled off.

Here, according to the following procedure, an acceleration factor was obtained using a temperature and a state of immersion in the electrolytic solution as acceleration conditions, and an acceleration test was performed to obtain the expected lifespan of the adhesive layer of the safety mechanism 10 of the battery.

The pressure release member 2 and the current shutoff member 3 of the safety mechanism 10 of the battery were immersed in the non-aqueous electrolytic solution under each environment of 25° C. and 85° C., and the adhesive strength was measured after a plurality of predetermined immersion periods had elapsed. As for the adhesive strength, a pressure was applied by a pushable gauge (MX2-500N manufactured by IMADA CO., LTD.), and an average value until the pressure release member 2 and the current shutoff member 3 were fully separated was taken as the adhesive strength. In addition, on the basis of the adhesive strength during a plurality of immersion periods obtained under each environment of 25° C. and 85° C., an inclination of deterioration of the adhesive strength with respect to the immersion period was calculated, and a first deterioration predicted acceleration α1 was obtained from the calculated inclination.

The adhesive strength was measured after the predetermined immersion periods had elapsed in each of a first state in which the safety mechanism 10 of the battery according to the present embodiment was fully immersed in the non-aqueous electrolytic solution under an environment of 85° C. and a second state in which the safety mechanism 10 of the battery was not immersed in the non-aqueous electrolytic solution but sealed in a container under a non-aqueous electrolytic solution atmosphere. A method for measuring the adhesive strength is the same as a measurement method described above. On the basis of the adhesive strength during the plurality of immersion periods obtained in the first state and the second state, the inclination of the deterioration of the adhesive strength with respect to the immersion period was calculated, and a second deterioration predicted acceleration α2 was obtained from the calculated inclination.

α1×α2 obtained by multiplying the obtained first deterioration predicted acceleration α1 and second deterioration predicted acceleration α2 was defined as an acceleration coefficient. Then, in the second state in which the safety mechanism 10 of the battery was sealed in the container under the environment of 85° C. and under the non-aqueous electrolytic solution atmosphere, a value obtained by multiplying the number of days until the adhesive strength reached 0 N by the acceleration coefficient was taken as the expected lifespan.

FIG. 10 illustrates the relationship between the expected lifespan and the adhesive strength of the adhesive layer of the safety mechanism 10 of the battery according to the second embodiment. The adhesive strength is an adhesive strength between the pressure release member 2 and the current shutoff member 3. FIG. 10(a) also illustrates, for comparison, data indicating the relationship between the expected lifespan and the adhesive strength of the adhesive layer of the safety mechanism 10 of the battery according to the first embodiment. Note that in FIG. 10, data of “with roughening treatment” is data of the safety mechanism 10 of the battery according to the second embodiment, and data of “without roughening treatment” is data of the safety mechanism 10 of the battery according to the first embodiment.

As illustrated in FIG. 10(a), in an initial state in which the expected lifespan is 0, that is, in a state before the acceleration test is performed, the safety mechanism 10 of the battery according to the second embodiment has a higher adhesive strength than the safety mechanism 10 of the battery according to the first embodiment. In addition, in the safety mechanism 10 of the battery according to the second embodiment, a rate of decrease in the adhesive strength due to age degradation is slower than that in the safety mechanism 10 of the battery according to the first embodiment. This is because, as described above, in the safety mechanism 10 of the battery according to the second embodiment, the pressure release member 2 and the adhesive layer 4, and the current shutoff member 3 and the adhesive layer 4 are fixed by hydrogen bonding and the anchor effect, whereas in the safety mechanism 10 of the battery according to the first embodiment, they are fixed only by hydrogen bonding.

A broken line D1 shown in FIG. 10(b) is an imaginary line indicating the relationship between the expected lifespan and the adhesive strength when the hydrogen bonds are broken in the battery safety mechanism 10 according to the second embodiment in which the pressure release member 2 and the adhesive layer 4, and the current shutoff member 3 and the adhesive layer 4 are fixed by hydrogen bonding and the anchor effect.

A broken line D2 shown in FIG. 10(b) is an imaginary line indicating the relationship between the expected lifespan and the adhesive strength when the hydrogen bonds between the pressure release member 2 and the adhesive layer 4, and the current shutoff member 3 and the adhesive layer 4 are broken and they are fixed only by the anchor effect in the safety mechanism 10 of the battery according to the second embodiment. The broken line D2 indicates a state in which the adhesive strength decreases as softening of the adhesive of the adhesive layer 4 progresses. The rate of decrease in the adhesive strength indicated by the broken line D2 is slower than that in the adhesive strength indicated by the broken line D1.

Here, the roughening treatment performed on the pressure release member 2 may be performed a plurality of times. By performing the roughening treatment a plurality of times, the surface area ratio of the pressure release member 2 can be further increased. Similarly, the roughening treatment performed on the current shutoff member 3 may be performed a plurality of times.

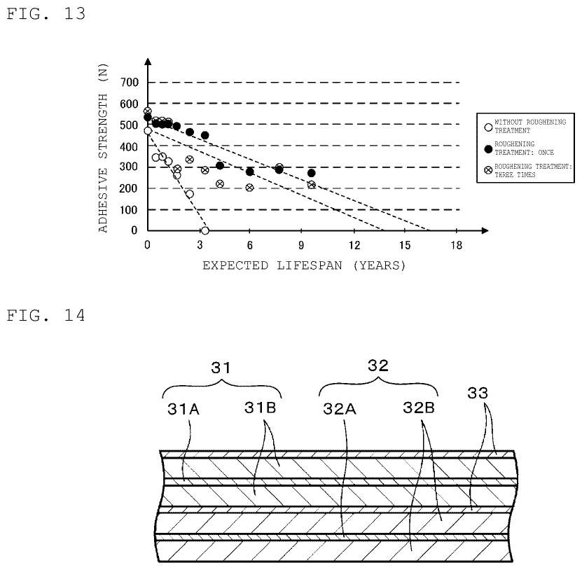

FIG. 11 is a view illustrating a relationship between the number of times of roughening treatment performed on the pressure release member 2 and the surface area ratio of the roughened surface of the pressure release member 2. Here, for a plurality of samples, the surface area ratio was determined when the number of times of roughening treatment was set to 0, 1, and 3. In FIG. 11, data of a black circle indicates the surface area ratio of each of the plurality of samples, and data of a white circle indicates an average value of a plurality of surface area ratios in a case where the number of times of the roughening treatment is the same. Note that when a material of the current shutoff member 3 and a material of the pressure release member 2 are the same, a view illustrating the relationship between the number of times of the roughening treatment performed on the current shutoff member 3 and the surface area ratio of the roughened surface of the current shutoff member 3 is also the same as that in FIG. 11.

The surface area ratio of the roughened surface of the pressure release member 2 is expressed by the following formula when a surface area of the roughened surface of the pressure release member 2 is S1 and a surface area when the pressure release member 2 is assumed to be a flat surface is S2.

Surface area ratio of roughened surface of pressure release member 2=(S1/S2−1)×100

Similarly, the surface area ratio of the roughened surface of the current shutoff member 3 is expressed by the following formula when a surface area of the roughened surface of the current shutoff member 3 is S3 and a surface area when the current shutoff member 3 is assumed to be a flat surface is S4.

Surface area ratio of roughened surface of current shutoff member 3=(S3/S4−1)×100

Note that the surface areas of the pressure release member 2 and the current shutoff member 3 were measured in a rectangular measurement range of 0.7 mm×0.5 mm using an optical surface profile measuring instrument NewView 7300 (manufactured by Zygo Corporation).

As illustrated n FIG. 11, as the number of times of the roughening treatment increases, the fine irregularities increase in the roughened surface, or a depth of a concave portion increases, and thus the surface area ratio of the pressure release member 2 increases. Similarly, for the current shutoff member 3, as the number of times of the roughening treatment increases, the surface area ratio of the current shutoff member 3 increases.

FIG. 12(a) is a view illustrating a surface state when the roughening treatment is not performed on the pressure release member 2, FIG. 12(b) is a view illustrating a surface state when the roughening treatment is performed on the pressure release member 2 once, and FIG. 12(c) is a view illustrating a surface state when the roughening treatment is performed on the pressure release member 2 twice. Each of FIGS. 12(a) to 12(c) is a view when observed with a microscope (VHX-8000 manufactured by KEYENCE CORPORATION, magnification: 500 times), where an upper view illustrates a state of the surface, and a lower view illustrates a state of a section.

FIG. 13 is a view illustrating the relationship between the expected lifespan and the adhesive strength when the number of times of the roughening treatment is changed. The adhesive strength is an adhesive strength between the pressure release member 2 and the current shutoff member 3. The number of times of the roughening treatment was 0, 1, and 3. As illustrated in FIG. 13, when the number of times of the roughening treatment is 1 or 3, the expected lifespan is longer than that when the roughening treatment is not performed. However, when the number of times of the roughening treatment is 3, the expected lifespan is shorter than that when the number of times of the roughening treatment is 1. That is, it is understood that the expected lifespan does not increase as the number of times of the roughening treatment is simply increased to increase the surface area ratio. This is considered to be because when the number of times of the roughening treatment is increased, the depth of the concave portion among the fine irregularities present on the surface of the pressure release member 2 formed by the roughening treatment is deeper, and the number of concave portions into which the adhesive does not enter increases.

From FIG. 13, the number of times of the roughening treatment applied to the roughened surface of the pressure release member 2 is preferably more than 0 and less than 3, and the number of times of the roughening treatment applied to the roughened surface of the current shutoff member 3 is preferably more than 0 and less than 3. In an example illustrated in FIG. 11, the average value of the surface area ratios of the roughened surface of the pressure release member 2 when the number of times of roughening treatment is 0 is 5.65%, the average value of the surface area ratios of the roughened surface when the number of times of roughening treatment is 1 is 15.66%, and the average value of the surface area ratios of the roughened surface when the number of times of roughening treatment is 3 is 26.10%. Therefore, the surface area ratio of the roughened surface of the pressure release member 2 is preferably 6% to 26%. Similarly, the surface area ratio of the roughened surface of the current shutoff member 3 is preferably 6% to 26%.

### Method for Manufacturing Safety Mechanism

An example of a method for manufacturing the safety mechanism 10 described above will be described.

First, the lid 1 and the pressure release member 2 are joined together. Specifically, the flat plate portion 1a of the lid 1 and the pressure release member 2 are joined together. A joining method is arbitrary, and joining can be achieved, for example, by welding such as ultrasonic welding.

Subsequently, the adhesive is applied to at least one of a surface of the pressure release member 2 on the side opposite to the lid 1 and a surface of the current shutoff member 3 on the projection 3b side, and the pressure release member 2 and the current shutoff member 3 are bonded together with the applied adhesive interposed therebetween. As described above, it is possible to use, as the adhesive, the epoxy resin-based adhesive, the acrylic resin-based adhesive, the fluororesin-based adhesive, the silicone resin-based adhesive, the synthetic resin-based adhesive, the urethane resin-based adhesive, or the like. A thickness of the adhesive to be applied is, for example, 0.1 mm to 0.4 mm, and an area to be applied is, for example, 0.6 mm² to 100 mm². Thus, the adhesive layer 4 is formed between the pressure release member 2 and the current shutoff member 3.

Finally, the projection 3b of the current shutoff member 3 is connected to the pressure release member 2. A connection method is arbitrary, and connection can be achieved, for example, by welding such as laser welding.

Note that the pressure release member 2 and the current shutoff member 3 may be first bonded to each other with the adhesive interposed therebetween, then the projection 3b of the current shutoff member 3 and the pressure release member 2 may be bonded to each other, and finally the lid 1 and the pressure release member 2 may be bonded to each other.

### Battery

Next, an example of a structure of the battery 100 including the safety mechanism 10 of the present disclosure will be described. The battery 100 includes the safety mechanism 10, the battery can 20, and the electrode assembly 30.

In the present embodiment, the battery can 20 has a hollow cylindrical shape with one end opened, and houses the electrode assembly 30. The battery can 20 includes, for example, iron (Fe) plated with nickel. Nickel, stainless steel, aluminum, titanium, or the like may be used as a material of the battery can 20. A surface of the battery can 20 may be plated with, for example, nickel or the like in order to prevent corrosion due to an electrochemical non-aqueous electrolytic solution associated with charging and discharging of a non-aqueous electrolyte battery.

The safety mechanism 10 is attached to a release end portion of the battery can 20 so that the lid 1 faces outward. Specifically, the safety mechanism 10 is attached to the battery can 20 by being crimped with a gasket 11 for an insulating seal interposed therebetween. An inside of the battery can 20 is thus hermitically sealed.

The electrode assembly 30 including a positive electrode 31, a negative electrode 32, and a separator 33 provided between the positive electrode 31 and the negative electrode 32 is housed inside the battery can 20. In the present embodiment, the electrode assembly 30 is a wound electrode assembly in which a pair of strip-shaped positive electrode 31 and strip-shaped negative electrode 32 are wound around a center pin 38 in a state where the positive electrode 31 and the negative electrode 32 are stacked with the separator 33 interposed therebetween. However, the electrode assembly 30 is not limited to the wound electrode assembly. In the battery 100 of the present disclosure, the electrode assembly 30 may have any configuration.

The positive electrode lead 36 is connected to the positive electrode 31, and a negative electrode lead 37 is connected to the negative electrode 32. As described above, the positive electrode lead 36 is connected to the current shutoff member 3 of the safety mechanism 10 of the battery, and is electrically connected to the lid 1 with the pressure release member 2 interposed therebetween. The negative electrode lead 37 is welded to the battery can 20, and electrically connected to the battery can 20.

An electrolytic solution as a liquid electrolyte is injected into the battery can 20. The positive electrode 31, the negative electrode 32, and the separator 33 are impregnated with the electrolytic solution. Further, a pair of insulating plates 34 and 35 are arranged perpendicular to a winding peripheral surface so as to sandwich the electrode assembly 30.

Hereinafter, the positive electrode 31, the negative electrode 32, the separator 33, and the electrolytic solution constituting the electrode assembly 30 will be sequentially described with reference to FIG. 14.

### Positive Electrode

The positive electrode 31 has, for example, a structure in which a positive electrode active material layer 31B is provided on both surfaces of a positive electrode current collector 31A. However, the positive electrode active material layer 31B may be provided only on one surface of the positive electrode current collector 31A. The positive electrode current collector 31A includes, for example, a metal foil such as an aluminum foil, a nickel foil, or a stainless-steel foil. The positive electrode active material layer 31B contains, for example, a positive electrode active material capable of occluding and releasing lithium which is an electrode reactant. The positive electrode active material layer 31B may further contain an additive, if necessary. For example, at least one of a conductive agent and a binder can be used as the additive.

As a positive electrode material capable of occluding and releasing lithium, for example, a lithium-containing compound such as a lithium oxide, a lithium phosphorus oxide, a lithium sulfide, or an interlayer compound containing lithium is suitable, and two or more kinds thereof may be mixed and used. In order to increase energy density, a lithium-containing compound containing lithium, a transition metal element, and oxygen (O) is preferably used. Examples of such a lithium-containing compound include a lithium composite oxide having a layered rock salt-type structure represented by formula (A), and a lithium composite phosphate having an olivine type structure represented by formula (B). The lithium-containing compound more preferably contains at least one selected from the group consisting of cobalt (Co), nickel, manganese (Mn), and iron as the transition metal element. Examples of such a lithium-containing compound include a lithium composite oxide having a layered rock salt-type structure represented by formula (C), formula (D), or formula (E), a lithium composite oxide having a spinel type structure represented by formula (F), and a lithium composite phosphate having an olivine type structure represented by formula (G), and specific examples thereof include LiNi_{0.50}Co_{0.20}Mn_{0.30}O₂, LiₐCoO₂ (a˜1), Li_{b}NiO₂ (b˜1), Li_{c1}Ni_{c2}Co_{1-c2}O₂ (c1˜1, 0<c2<1), Li_{d}Mn₂O₄ (d˜1), and LiₑFePO₄ (e˜1).

LiₚNi_{(1-q-r)}Mn_{q}M1ᵣO_{(2-y)}X_{z} (A)

In the formula (A), M1 represents at least one of elements selected from Group 2 to Group 15 excluding nickel and manganese. X represents at least one among Group 16 elements and Group 17 elements other than oxygen. p, q, r, y, and z are values within ranges of 0≤p≤1.5, 0≤q≤1.0, 0≤r≤1.0, −0.10≤y≤0.20, and 0≤z≤0.2.

LiₐM2_{b}PO₄ (B)

In the formula (B), M2 represents at least one of elements selected from Group 2 to Group 15. a and b are values within ranges of 0≤a≤2.0 and 0.5≤b≤2.0.

Li_{f}Mn_{(1-g-h)}Ni_{g}M3ₕO₍₂₋ⱼ₎Fₖ (C)

In the formula (C), M3 represents at least one from the group consisting of cobalt, magnesium (Mg), aluminum, boron (B), titanium (Ti), vanadium (V), chromium (Cr), iron, copper (Cu), zinc (Zn), zirconium (Zr), molybdenum (Mo), tin (Sn), calcium (Ca), strontium (Sr), and tungsten (W). f, g, h, j, and k are values within ranges of 0.8≤f≤1.2, 0<g<0.5, 0≤h≤0.5, g+h<1, −0.1≤j≤0.2, and 0≤k≤0.1. Note that composition of lithium varies depending on a state of charge and discharge, and a value of f represents a value in a fully discharged state.

LiₘNi₍₁₋ₙ₎M4ₙO₍₂₋ₚ₎F_{q} (D)

In the formula (D), M4 represents at least one selected from the group consisting of cobalt, manganese, magnesium, aluminum, boron, titanium, vanadium, chromium, iron, copper, zinc, molybdenum, tin, calcium, strontium, and tungsten. m, n, p, and q are values within ranges of 0.8≤m≤1.2, 0.005≤n≤0.5, −0.1≤p≤0.2, and 0≤q≤0.1. Note that the composition of lithium varies depending on the state of charge and discharge, and a value of m represents a value in the fully discharged state.

LiᵣCO₍₁₋ₛ₎M5ₛO₍₂₋ₜ₎Fᵤ (E)

In the formula (E), M5 represents at least one selected from the group consisting of nickel, manganese, magnesium, aluminum, boron, titanium, vanadium, chromium, iron, copper, zinc, molybdenum, tin, calcium, strontium, and tungsten. r, s, t, and u are values within ranges of 0.8≤r≤1.2, 0≤s<0.5, −0.1≤t≤0.2, and 0≤u≤0.1. Note that the composition of lithium varies depending on the state of charge and discharge, and a value of r represents a value in the fully discharged state.

LiᵥMn_{2-w}M6_{w}OₓF_{y} (F)

In the formula (F), M6 represents at least one selected from the group consisting of cobalt, nickel, magnesium, aluminum, boron, titanium, vanadium, chromium, iron, copper, zinc, molybdenum, tin, calcium, strontium, and tungsten. v, w, x, and y are values within ranges of 0.9≤v≤1.1, 0≤w≤0.6, 3.7≤x≤4.1, and 0≤y≤0.1. Note that the composition of lithium varies depending on the state of charge and discharge, and a value of v represents a value in the fully discharged state.

Li_{z}M7PO₄ (G)

In the formula (G), M7 represents at least one selected from the group consisting of cobalt, manganese, iron, nickel, magnesium, aluminum, boron, titanium, vanadium, niobium (Nb), copper, zinc, molybdenum, calcium, strontium, tungsten, and zirconium. z is a value within a range of 0.9≤z≤1.1. Note that the composition of lithium varies depending on the state of charge and discharge, and a value of z represents a value in the fully discharged state.

In addition to these compounds, examples of the positive electrode material capable of occluding and releasing lithium include inorganic compounds not containing lithium, such as MnO₂, V₂O₅, V₆O₁₃, NiS, and MOS.

The positive electrode material capable of occluding and releasing lithium may be a material other than those mentioned above. Further, two or more of the positive electrode materials exemplified above may be mixed in arbitrary combination.

As the binder, for example, at least one selected from resin materials such as polyvinylidene fluoride (PVdF), polytetrafluoroethylene (PTFE), polyacrylonitrile (PAN), styrene butadiene rubber (SBR), and carboxymethyl cellulose (CMC), copolymers mainly containing these resin materials, and the like can be used.

Examples of the conductive agent include carbon materials such as graphite, carbon black, and Ketjen black, and one or more of them can be used in combination. Further, in addition to the carbon materials, it is also possible to use conductive materials such as metal materials or conductive polymer materials as the conductive agent.

### Negative Electrode

The negative electrode 32 has, for example, a structure in which a negative electrode active material layer 32B is provided on both surfaces of a negative electrode current collector 32A. However, the negative electrode active material layer 32B may be provided only on one surface of the negative electrode current collector 32A. The negative electrode current collector 32A includes, for example, a metal foil such as a copper foil, a nickel foil, or a stainless-steel foil.

The negative electrode active material layer 32B contains one or two or more negative electrode active materials capable of occluding and releasing lithium. The negative electrode active material layer 32B may further contain an additive such as a binder and a conductive agent, if necessary.

Note that in the battery 100 which is the non-aqueous electrolyte battery, it is preferable that an electrochemical equivalent of the negative electrode 32 or the negative electrode active material is larger than that of the positive electrode 31, and theoretically, lithium metal is not deposited on the negative electrode 32 during charging.

Examples of the negative electrode active material include carbon materials such as non-graphitizable carbon, graphitizable carbon, graphite, pyrolytic carbons, cokes, glassy carbons, organic polymer compound fired bodies, carbon fibers, and activated carbon. Examples of the cokes include pitch coke, needle coke, and petroleum coke. The organic polymer compound fired body refers to a carbonized product obtained by firing a polymer material such as a phenol resin or a furan resin at an appropriate temperature, and some are classified as non-graphitizable carbon or graphitizable carbon. These carbon materials are preferable because a change in crystal structure generated during charge and discharge is very small, a high charge and discharge capacity can be obtained, and good cycle characteristics can be obtained. In particular, graphite is preferable because it has a large electrochemical equivalent and a high energy density can be obtained. Non-graphitizable carbon is preferable because excellent cycle characteristics can be obtained. Further, those having a low charge and discharge potential, specifically, those having a charge and discharge potential close to that of lithium metal are preferable because a high energy density of the battery 100 can be easily obtained.

Examples of other negative electrode active materials capable of increasing the capacity include materials containing at least one of metal elements and metalloid elements as a constituent element (for example, an alloy, a compound, or a mixture). This is because the high energy density can be obtained by using such a material. In particular, when such a material is used together with a carbon material, the high energy density can be obtained and excellent cycle characteristics can be obtained, which is more preferable. Note that the alloy includes an alloy containing one or more metal elements and one or more metalloid elements in addition to an alloy containing two or more metal elements. The material of the negative electrode active material may contain a nonmetallic element. A structure thereof includes a solid solution, a eutectic (eutectic mixture), an intermetallic compound, or a mixture in which two or more of them coexist.

Examples of such a negative electrode active material include a metal element or a metalloid element capable of forming an alloy with lithium. Specific examples thereof include magnesium, boron, aluminum, titanium, gallium (Ga), indium (In), silicon (Si), germanium (Ge), tin, lead (Pb), bismuth (Bi), cadmium (Cd), silver (Ag), zinc, hafnium (Hf), zirconium, yttrium (Y), palladium (Pd), and platinum. These elements may be crystalline or amorphous.

The negative electrode active material preferably contains a metal element or metalloid element of Group 4B in the short periodic table as a constituent element, and more preferably contains at least one of silicon and tin as the constituent element. This is because silicon and tin have a great ability to occlude and release lithium and the high energy density can be obtained. Examples of such a negative electrode active material include a simple substance, an alloy, or a compound of silicon, a simple substance, an alloy, or a compound of tin, and a material having one or two or more phases thereof at least as a part of the material.

Examples of second constituent elements other than silicon constituting the alloy of silicon include those containing at least one of the group consisting of tin, nickel, copper, iron, cobalt, manganese, zinc, indium, silver, titanium, germanium, bismuth, antimony (Sb), and chromium. Examples of the second constituent elements other than tin constituting the alloy of tin include those containing at least one of the group consisting of silicon, nickel, copper, iron, cobalt, manganese, zinc, indium, silver, titanium, germanium, bismuth, antimony, and chromium.

Examples of the compound of tin or the compound of

silicon include those containing oxygen or carbon. These compounds may include the second constituent element described above.

Above all, a SnCoC-containing material containing

cobalt, tin, and carbon as the constituent elements, having carbon content of 9.9 mass % to 29.7 mass %, and having a proportion of cobalt to a total of tin and cobalt of 30 mass % to 70 mass % is preferable as a Sn-based negative electrode active material. This is because the high energy density can be obtained in the above composition range and excellent cycle characteristics can be obtained.

The SnCoC-containing material described above may further contain other constituent elements, if necessary. The other constituent element is preferably, for example, silicon, iron, nickel, chromium, indium, niobium, germanium, titanium, molybdenum, aluminum, phosphorus (P), gallium, or bismuth, and two or more of the above elements may be contained. This is because the capacity or the cycle characteristics can be further improved by containing the above elements as the other constituent elements.

Note that the SnCoC-containing material described above has a phase containing tin, cobalt, and carbon, and this phase preferably has a structure having a low crystallinity or being amorphous. Further, in the SnCoC-containing material, at least a part of carbon which is the constituent element is preferably bonded to a metal element or a metalloid element which is another constituent element. It is considered that deterioration of the cycle characteristics is caused by aggregation or crystallization of tin or the like, but it is because such aggregation or crystallization can be suppressed by bonding carbon to another element.

Examples of a measurement method for examining a bonding state of elements include X-ray photoelectron spectroscopy (XPS). In the XPS, in a case of graphite, a peak of 1s orbit of carbon (C1s) appears at 284.5 eV in an apparatus energy-calibrated so that a peak of 4f orbit of a gold atom (Au4f) is obtained at 84.0 eV. Further, in a case of surface contaminated carbon, the peak appears at 284.8 eV. In contrast, when a charge density of carbon element is high, for example, when carbon is bonded to the metal element or the metalloid element, the peak of C1s appears in a region lower than 284.5 eV. That is, when a peak of a combined wave of C1s obtained for the SnCoC-containing material appears in the region lower than 284.5 eV, at least a part of carbon contained in the SnCoC-containing material is bonded to the metal element or the metalloid element which is another constituent element.

Note that in XPS measurement, for example, the peak of C1s is used to correct an energy axis of a spectrum. In general, since the surface contaminated carbon is present on the surface, the peak of C1s of the surface contaminated carbon is set to 284.8 eV, which is used as an energy reference. In the XPS measurement, since a waveform of the peak of C1s is obtained as a form including a peak of the surface contaminated carbon and a peak of carbon in the SnCoC-containing material, the peak of the surface contaminated carbon and the peak of the carbon in the SnCoC-containing material are separated by, for example, analysis using commercially available software. In waveform analysis, a position of a main peak present on a lowest binding energy side is set as the energy reference (284.8 eV).

Examples of other negative electrode active materials include metal oxides or polymer compounds capable of occluding and releasing lithium. Examples of the metal oxides include lithium titanium oxide containing titanium and lithium, such as lithium titanate (Li₄Ti₅O₁₂), iron oxide, ruthenium oxide, and molybdenum oxide. Examples of the polymer compounds include polyacetylene, polyaniline, and polypyrrole.

As the binder, at least one selected from, for example, resin materials such as polyvinylidene fluoride, polytetrafluoroethylene, polyacrylonitrile, styrene butadiene rubber, and carboxymethylcellulose, and a copolymer including the resin materials as a main component is used. As the conductive agent, similar carbon materials to those of the positive electrode active material layer 31B and the like can be used.

### Separator

The separator 33 separates the positive electrode 31 and the negative electrode 32, and allows lithium ions to pass therethrough while preventing short circuit of current due to contact between both electrodes. The separator 33 includes, for example, a porous film made of a resin such as polytetrafluoroethylene, polypropylene, or polyethylene. The separator 33 may have a structure in which the above-described two or more kinds of porous films are laminated. Above all, the porous film made of polyolefin is preferable because of having an excellent effect of preventing short circuit and allowing improvement in safety of the battery 100 by a shutdown effect. In particular, polyethylene is preferable as a material constituting the separator 33 because polyethylene can obtain the shutdown effect within a range of 100° C. to 160° C. and is also excellent in electrochemical stability. In addition, as a material of the separator 33, a material obtained by copolymerizing or blending a resin having chemical stability with polyethylene or polypropylene can be used. The porous film may have a structure of three or more layers in which a polypropylene layer, a polyethylene layer, and a polypropylene layer are sequentially laminated.

Further, the separator 33 may be provided with a resin layer on one side or both sides of the porous film as a substrate. The resin layer is a porous matrix resin layer carrying an inorganic substance. With such a structure, oxidation resistance can be obtained to suppress deterioration of the separator 33. As a matrix resin, for example, polyvinylidene fluoride, hexafluoropropylene (HFP), polytetrafluoroethylene, or the like, or a copolymer thereof can be used.

Examples of the inorganic substance include a metal, a semiconductor, or an oxide or nitride thereof. In that case, examples of the metal include aluminum and titanium, and examples of the semiconductor include silicon and boron. As the inorganic substance, an inorganic substance having substantially no conductivity and a large heat capacity is preferable. This is because a large heat capacity is useful as a heat sink at the time of current heat generation, and thermal runaway of the battery 100 can be further suppressed. Examples of such inorganic substances include oxides or nitrides such as alumina (Al₂O₃), boehmite (alumina monohydrate), talc, boron nitride (BN), aluminum nitride (AlN), titanium dioxide (TiO₂), and silicon oxide (SiOₓ).

A particle size of the inorganic substance is preferably in a range of 1 nm to 10 μm. When the particle size of the inorganic substance is smaller than 1 nm, it is difficult to obtain the inorganic substance, and no matter when the inorganic substance can be obtained, it is not suitable in terms of cost. When the particle size of the inorganic substance is more than 10 μm, a distance between the electrodes is large, a filling amount of the active material cannot be sufficiently obtained in a limited space, and battery capacity decreases.

The resin layer of the separator 33 can be formed, for example, by applying a slurry containing a matrix resin, a solvent, and an inorganic substance onto the substrate (porous film), passing the slurry through a good solvent bath of a poor solvent of the matrix resin and the solvent to cause phase separation, and then drying the slurry.

A piercing strength of the separator 33 is preferably in a range of 100 gf to 1000 gf. The piercing strength of the separator 33 is more preferably in a range of 100 gf to 480 gf. This is because when the piercing strength is too low, short circuit may occur, and when it is too high, ion conductivity will decrease.

An air permeability of the separator 33 is preferably in a range of 30 sec/100 cc to 1000 sec/100 cc. The air permeability of the separator 33 is more preferably in a range of 30 sec/100 cc to 680 sec/100 cc. This is because when the air permeability of the separator 33 is too low, short circuit may occur, and when it is too high, the ion conductivity will decrease.

Note that the inorganic substance described above may be contained in the porous film as the substrate.

### Electrolytic Solution

The separator 33 is impregnated with an electrolytic solution which is a liquid electrolyte. The electrolytic solution contains a solvent and an electrolyte salt dissolved in the solvent. The electrolytic solution may include a known additive to improve characteristics of the battery 100.

As the solvent, cyclic carbonic acid esters such as an ethylene carbonate and a propylene carbonate can be used, and it is preferable to use one of ethylene carbonate and propylene carbonate, particularly a mixture of both. This is because the cycle characteristics can be improved in this case.

Further, as the solvent, in addition to the cyclic

carbonic acid esters described above, a chain carbonic acid ester such as diethyl carbonate, dimethyl carbonate, ethyl methyl carbonate, or methyl propyl carbonate is preferably mixed and used. This is because high ion conductivity can be obtained in this case.

Further, it is preferable that the solvent further contains 2,4-difluoroanisole or vinylene carbonate. This is because 2,4-difluoroanisole can improve the discharge capacity and vinylene carbonate can improve the cycle characteristics. Therefore, it is more preferable to use a mixture of 2,4-difluoroanisole and vinylene carbonate because the discharge capacity and the cycle characteristics can be improved.

In addition, examples of the solvent include butylene carbonate, γ-butyrolactone, γ-valerolactone, 1,2-dimethoxyethane, tetrahydrofuran, 2-methyltetrahydrofuran, 1,3-dioxolane, 4-methyl-1,3-dioxolane, methyl acetate, methyl propionate, acetonitrile, glutaronitrile, adiponitrile, methoxyacetonitrile, 3-methoxypropylnitrile, N,N-dimethylformamide, N-methylpyrrolidinone, N-methyloxazolidinone, N,N-dimethylimidazolidinone, nitromethane, nitroethane, sulfolane, dimethyl sulfoxide, and trimethyl phosphate.

Note that a compound obtained by substituting at least some of hydrogen atoms of non-aqueous solvents with fluorine may be preferable because reversibility of an electrode reaction may be improved depending on the type of electrodes to be combined.

Examples of the electrolyte salt include a lithium salt. The lithium salt may be used alone or in combination of two or more kinds thereof. Examples of the lithium salt include LiPF₆, LiBF₄, LiAsF₆, LiClO₄, LiB(C₆H₅)₄, LiCH₃SO₃, LiCF₃SO₃, LiN(SO₂CF₃)₂, LiC(SO₂CF₃)₃, LiAlCl₄, LiSiF₆, LiCl, lithium difluoro [oxolato-O,O′] borate, lithium bisoxalate borate, and LiBr. Above all, LiPF₆ is preferable because the high ion conductivity can be obtained and the cycle characteristics can be improved.

### Operation of Battery

In the battery 100 having the above-described configuration, when charging is performed, for example, lithium ions are released from the positive electrode active material layer 31B and occluded in the negative electrode active material layer 32B via the electrolytic solution. Further, when discharging is performed, for example, lithium ions are released from the negative electrode active material layer 32B and occluded in the positive electrode active material layer 31B via the electrolytic solution.

### Method for Manufacturing Battery

An example of a method for manufacturing the battery 100 described above will be described below.

First, the positive electrode material capable of lithium doping and dedoping, the conductive agent, and the binder are mixed to prepare a positive electrode mixture, and the positive electrode mixture is dispersed in a mixed solvent to obtain a positive electrode mixture slurry. Subsequently, the positive electrode mixture slurry is applied to the positive electrode current collector 31A, dried, and then subjected to compression molding to prepare the positive electrode 31. Thereafter, the positive electrode lead 36 is connected to the positive electrode current collector 31A by ultrasonic welding, spot welding, or the like.

Further, a negative electrode material capable of lithium doping and dedoping and a binder are mixed to prepare a negative electrode mixture, and the negative electrode mixture is dispersed in the mixed solvent to obtain a negative electrode mixture slurry. Subsequently, the negative electrode mixture slurry is applied to the negative electrode current collector 32A, dried, and then subjected to compression molding to prepare the negative electrode 32. Thereafter, the negative electrode lead 37 is connected to the negative electrode current collector 32A by ultrasonic welding, spot welding, or the like.

Subsequently, the positive electrode 31 and the negative electrode 32 are wound many times in a state of being laminated with the separator 33 interposed therebetween, to prepare the electrode assembly 30. Thereafter, the electrode assembly 30 is sandwiched between the pair of insulating plates 34 and 35, and housed in the battery can 20. Further, the positive electrode lead 36 is connected to the current shutoff member 3 of the safety mechanism 10, and the negative electrode lead 37 is connected to the battery can 20.

Subsequently, the electrolytic solution is prepared by dissolving the electrolyte salt in the solvent. Thereafter, the electrolytic solution is injected into the battery can 20 to be impregnated into the separator 33. Subsequently, the safety mechanism 10 is attached to a release end of the battery can 20 by being crimped with the gasket 11 interposed therebetween.

The battery 100 is completed by the method described above. Note that a resin ring washer may be attached to the lid 1, or the entire battery 100 may be covered with a resin tube.

The present disclosure is not limited to the above embodiment, and various applications and modifications can be made within the scope of the present disclosure.

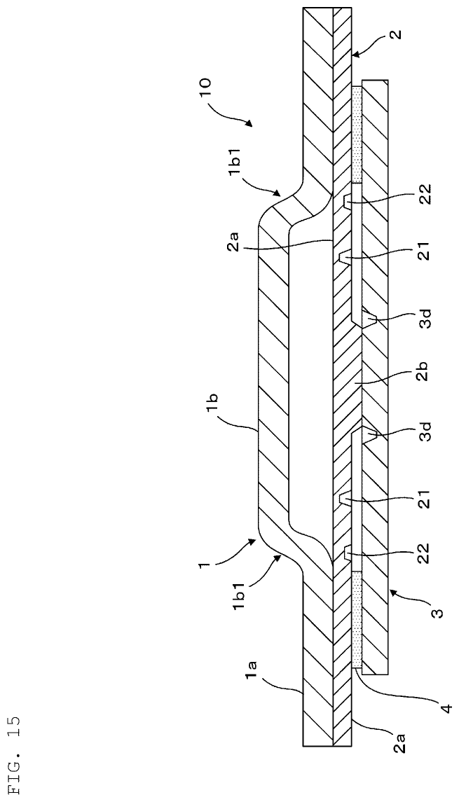

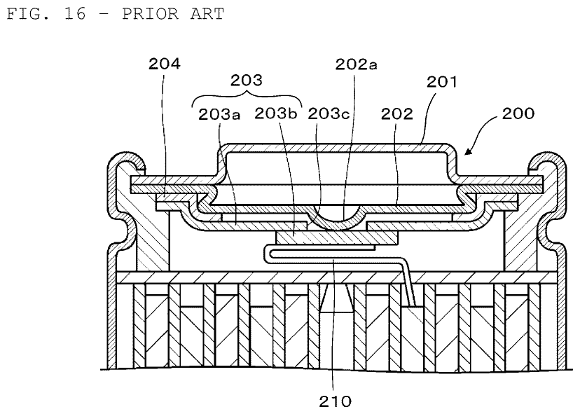

For example, in the battery 100 according to the embodiment described above, the current shutoff member 3 has the projection 3b for connecting to the pressure release member 2 and the flat plate portion 3a having a flat plate shape, and the pressure release member 2 has a flat plate shape. However, as illustrated in FIG. 15, it may be configured such that the pressure release member 2 includes a projection 2b for connecting to the current shutoff member 3 and a flat plate portion 2a having a flat plate shape, and the current shutoff member 3 has a flat plate shape. In any case, since both the pressure release member 2 and the current shutoff member 3 have a thin, flat or substantially flat shape, the battery safety mechanism 10 of the battery can be thinned. Thus, for example, when the size of the battery 100 is determined, sizes of the positive electrode 31, the negative electrode 32, and the like can be increased, so that the capacity of the battery 100 can be further increased.

Further, in the battery 100 according to the embodiment described above, the pressure release member 2 has a flat plate shape, but may have a portion bent toward the current shutoff member 3 as in the disk plate of the battery described in Patent Document 1. Similarly, the flat plate portion 3a of the current shutoff member 3, which is a portion other than the projection 3b, has a flat plate shape, but may have a portion bent toward the electrode assembly as in the shutoff disk of the battery described in Patent Document 1.

### DESCRIPTION OF REFERENCE SYMBOLS

1: Lid
1a: Flat plate portion of lid
1b: Protrusion portion of lid
1c: Discharge hole of lid
2: Pressure release member
2a: Flat plate portion of pressure release member
2b: Projection of pressure release member
3: Current shutoff member
3a: Flat plate portion of current shutoff member
3b: Projection of current shutoff member
3c: Hole
3d: Groove of current shutoff member
4: Adhesive layer
10: Safety mechanism of battery
11: Gasket
20: Battery can
21: First groove
22: Second groove
30: Electrode assembly
31: Positive electrode
32: Negative electrode
33: Separator
34, 35: Insulating plate
36: Positive electrode lead
37: Negative electrode lead
38: Center pin
100: Battery

1. A safety mechanism of a battery comprising:
a lid;
a pressure release member in contact with the lid and constructed to be deformed when an internal pressure of the battery increases so as to release a gas inside the battery to an outside of the battery;
a current shutoff member on a side opposite to the lid with respect to the pressure release member, and connected to the pressure release member so as to shut off a current flowing to the pressure release member when the internal pressure of the battery increases; and
an insulating adhesive layer interposed between the pressure release member and the current shutoff member and bonding the pressure release member to the current shutoff member.

2. The safety mechanism of the battery according to claim 1, wherein
a surface of the pressure release member facing the current shutoff member is a roughened surface, and
a surface of the current shutoff member facing the pressure release member is a roughened surface.

3. The safety mechanism of the battery according to claim 2, wherein
a surface area ratio of the roughened surface of the pressure release member is 6% to 26%, and
a surface area ratio of the roughened surface of the current shutoff member is 6% to 26%.

4. The safety mechanism of the battery according to claim 1, wherein the insulating adhesive layer includes any one of a thermosetting resin, a thermoplastic resin, a UV curable resin, and an anaerobic adhesive.

5. The safety mechanism of the battery according to claim 4, wherein the insulating adhesive layer includes a thermosetting resin having a glass transition temperature of 100° C. or higher.

6. The safety mechanism of the battery according to claim 5, wherein the thermosetting resin is an epoxy resin.

7. The safety mechanism of the battery according to claim 4, wherein the insulating adhesive layer includes a thermoplastic resin having a melting point of 200° C. or higher.

8. The safety mechanism of the battery according to claim 1, wherein the insulating adhesive layer is discontinuously arranged at a plurality of positions between the pressure release member and the current shutoff member.

9. The safety mechanism of the battery according to claim 1, wherein a thickness of the adhesive layer is 0.05 mm to 0.4 mm.

10. The safety mechanism of the battery according to claim 1, wherein an area of the adhesive layer is 0.6 mm² to 100 mm².

11. The safety mechanism of the battery according to claim 1, wherein the current shutoff member includes a projection that
connects to the pressure release member and a flat plate portion having a flat plate shape, and
the pressure release member has a flat plate shape.

12. The safety mechanism of the battery according to claim 1, wherein
the pressure release member includes a projection that connects to the current shutoff member and a flat plate portion having a flat plate shape, and
the current shutoff member has a flat plate shape.

13. The safety mechanism of the battery according to claim 1, wherein a material of the current shutoff member includes at least one of aluminum, titanium, platinum, and gold.

14. The safety mechanism of the battery according to claim 1, wherein a material of the pressure release member includes at least one of aluminum, titanium, platinum, and gold.

15. The safety mechanism of the battery according to claim 1, wherein the pressure release member has at least one groove.

16. The safety mechanism of the battery according to claim 15, wherein the at least one groove is a plurality of grooves.

17. The safety mechanism of the battery according to claim 16, wherein the plurality of grooves include:
a first groove; and
a second groove located radially outside the first groove.

18. The safety mechanism of the battery according to claim 17, wherein a first depth of the first groove and a second depth of the second groove are different from each other.

19. A battery comprising:
an electrode assembly including a positive electrode, a negative electrode, and a separator between the positive electrode and the negative electrode;
a battery can that houses the electrode assembly; and
the safety mechanism of the battery according to claim 1 attached to the battery can.

20. The battery according to claim 19, wherein the battery can is a cylindrical battery can of a lithium ion secondary battery.
